(19) United States
(12) Patent Application Publication
(10) Pub. No.: US 2005/0015365 A1
(43) Pub. Date: Jan. 20, 2005

(54) Hierarchical configuration attribute storage and retrieval

(76) Inventors: Sathyanarayanan N. Kavacheri, Sunnyvale, CA (US); Luu D. Tran, Santa Clara, CA (US)

Correspondence Address: WAGNER, MURABITO & HAO LLP, Third Floor, Two North Market Street, San Jose, CA, 95113, US

(21) Appl. No.: 10/622,151

(22) Filed: Jul. 16, 2003

(51) Int. Cl. G06F 7/00

(52) U.S. Cl. 707/3

(57) ABSTRACT

Methods and systems thereof for storing and retrieving device-dependent attributes on a portal server are described. Attributes are stored in a device-dependent fashion. When a request for an attribute is received, the type of device used to generate the request is identified. The attribute suitable for the type of device is selected. Accordingly, device-dependent attributes are readily stored and retrieved on the portal server. As a result, the portal server can quickly and efficiently provide services and other types of support for a wide variety of client devices having different characteristics.

### RELATED UNITED STATES PATENT APPLICATIONS

This Application is related to U.S. patent application Ser. No. ______ by Lu Tran et al., filed on Jul. 16, 2003, entitled “Method and System for Storing and Retrieving Extensible Multi-Dimensional Display Property Configurations,” with Attorney Docket No. SUN-PO₃₀₀₆₃, and assigned to the assignee of the present invention.

This Application is related to U.S. patent application Ser. No. ______ by John Saare and Thomas Mueller, filed on Jul. 16, 2003, entitled “A Method and System for Device Specific Application Optimization via a Portal Server,” with Attorney Docket No. SUN-PO₃₀₀₈₂, and assigned to the assignee of the present invention.

Application is related to U.S. patent application Ser. No. ______ by John Saare and Thomas Mueller, filed on Jul. 16, 2003, entitled “System and Method for Single-Sign-On Access to a Resource via a Portal Server,” with Attorney Docket No. SUN-PO₃₀₀₈₃, and assigned to the assignee of the present invention.

### BACKGROUND OF THE INVENTION

1. Field of the Invention

Embodiments of the present invention generally pertain to portal servers. More specifically, embodiments of the present invention pertain to computer-implemented methods for storing and retrieving device-dependent attributes on a portal server.

2. Related Art

A portal server, generally speaking, is a specialized sort of Web server. A portal server utilizes software that manages user access to Web applications and services that are available over the Internet as well as over corporate intranets. A typical Web page is relatively anonymous, providing generalized content that is the same for all users. A portal is more personalized than a typical Web page, providing a Web page customized to a user or group of users. A portal can also provide services such as electronic mail (e-mail), calendar, and address book services.

A shortcoming of conventional Web servers as well as portal servers arises from the overwhelming diversity in the types of devices that can be used to access Web applications and services. Initially, Web applications and services were accessed using a personal computer that was running a Web browser. Though there was some diversity in types of personal computers, the vast majority of personal computers (PCs) used one of a small number of operating systems, and were equipped with a full-sized display monitor and large memories. Similarly, although there was some diversity in browsers, browsers generally used HyperText Markup Language (HTML). Consequently, Web pages could be designed using HTML for execution on a resource-rich, PC using some type of popular operating system, with a reasonable expectation that the Web pages could be used by just about everyone.

However, this paradigm is being challenged because of the profusion of mobile devices such as cell phones and personal digital assistants (PDAs) that now have the capability to access the Web. These devices have processing and memory capabilities that rival early computers, but remain limited in comparison to contemporary PCs. Thus, while mobile devices can access the Web, they do not necessarily have the capacity to use a Web page designed for a more powerful computer system. Also, as mentioned above, a Web page is typically designed for use on a full-size monitor. In comparison, the displays used by mobile devices are much smaller and provide less resolution. As such, a Web page designed for a PC may not be legible on a mobile device, or only a small portion of the Web page may be displayed at a time.

Furthermore, mobile devices typically do not use HTML, relying instead on different markup languages such as Wireless Markup Language (WML). As a consequence, a Web page written using HTML may not be decipherable on a mobile device.

### SUMMARY OF THE INVENTION

Accordingly, a Web server, in particular a portal server, that can provide content, in particular Web-based content, to mobile devices and other types of limited-resource devices would be advantageous. However, there are possibly tens of thousands of different types of mobile devices in use, and the number is growing. The number of portal-based applications that can be used by these devices is also quite large. Associated with each of these applications are attributes that can be device-dependent. Hence, the number of application attributes that are device-dependent is expected to be quite large as well. A portal server that can efficiently and quickly manage (e.g., store and retrieve) these application attributes would also be advantageous. Embodiments of the present invention provide these advantages.

According to one embodiment of the present invention, a device-dependent attribute stored on a portal server is retrieved as follows. Communication with a device is established, and the type of device is identified. A characteristic of the type of device is also identified. An entry is selected from a list of attributes. The entry is selected first according to the type of device and second according to the characteristic if the list does not include an entry that corresponds to the type of device.

For example, an attribute might be a bookmark or a Uniform Resource Locator that is dependent on the type of device or on the characteristics of the device. The type of device may be its brand name and model number. A characteristic of the type of device may be the type of markup language used by the device. The device may use either HyperText Markup Language (HTML) or Wireless Markup Language (WML), for example. The list of attributes may be sorted into categories; for example, there may be a category for each combination of brand name and model number and a category for each type of markup language. When communication is established with a device, the device's brand name and model number are identified, and the type of markup language used by the device is also identified. If there is a category corresponding to the device's specific combination of brand name and model number, then an attribute for the device can be selected from that category. If such a category does not exist, then an attribute can be selected from the category for the type of markup language used by the device.

According to another embodiment of the present invention, device-dependent attributes are stored in a portal server as follows. Information is received that identifies a type of device for which an attribute is to be stored. The attribute is dependent on the type of device. An attribute is selected according to the type of device. The selected attribute is entered into a list of attributes. The list is organized into type-specific categories. The attribute is entered into an existing type-specific category provided such a category exists. A type-specific category for the attribute is created provided such a category does not already exist.

Consider again the example described above. The brand name and model number of a device are identified, and an attribute for that combination of brand name and model-number is selected. The selected attribute is added into a category corresponding to the device's specific combination of brand name and model number, if such a category already exists. If such a category does not exist, then a category corresponding to the specific combination of brand name and model number is created, and the attribute is entered into that category.

In summary, embodiments of the present invention allow device-dependent attributes to be readily stored and retrieved on a portal server. As a result, the portal server can quickly and efficiently provide services and other types of support for a wide variety of client devices having different characteristics. These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of a hardware architecture for an exemplary computer system upon which embodiments of the present invention can be implemented.

FIG. 2 is a block diagram showing the elements of a software architecture implemented on a portal server according to one embodiment of the present invention.

FIG. 3 is a block diagram of an exemplary network including a portal server according to one embodiment of the present invention.

FIG. 4 is a representation of a list of device-dependent attributes used with a portal server according to an embodiment of the present invention.

FIG. 5 is a representation of a portion of a directory used by a portal server according to an embodiment of the present invention.

FIG. 6 is a flowchart of one embodiment of a computer-implemented process for retrieving device-dependent attributes according to embodiments of the present invention.

FIG. 7 is a flowchart of one embodiment of a computer-implemented process for storing device-dependent attributes according to embodiments of the present invention.

FIG. 8 is a tabulation of one embodiment of an interface for storing and retrieving device-dependent attributes according to embodiments of the present invention.

### DETAILED DESCRIPTION OF THE INVENTION

Reference will now be made in detail to the various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

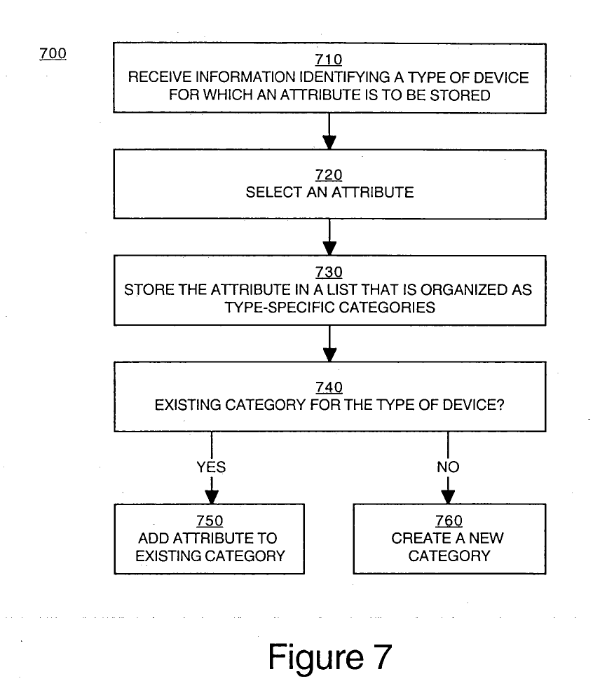

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “establishing,” “identifying,” “selecting,” “storing,” “creating,” “receiving,” “communicating,” “associating,” “entering,” “retrieving” or the like, refer to the action and processes (e.g., flowcharts 600 and 700 of FIGS. 6 and 7, respectively) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

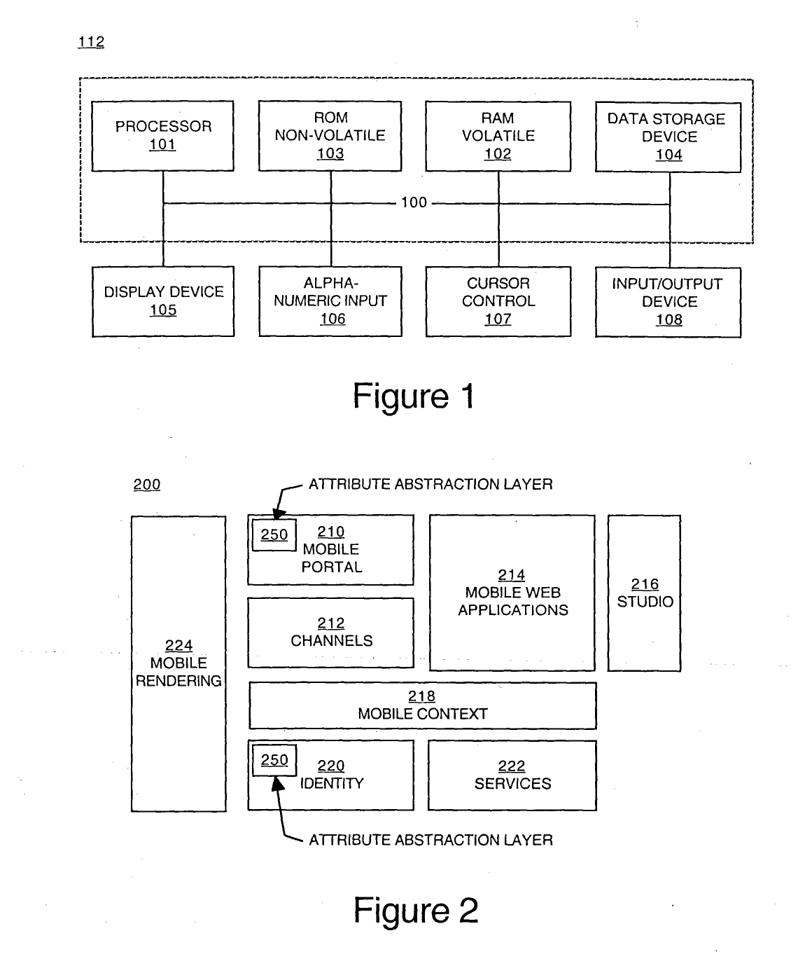

FIG. 1 is a block diagram of an exemplary computer system 112 (e.g., a portal server system) upon which embodiments of the present invention can be implemented. It is appreciated that computer system 112 described herein illustrates an exemplary configuration of an operational platform. Nevertheless, other computer systems with differing configurations can also be used in place of computer system 112 within the scope of the present invention.

Computer system 112 includes an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, EPROM, EEPROM, etc.) coupled with bus 100 for storing static information and instructions for processor 101. Computer system 112 can also contain an optional display device 105 coupled to bus 100 for displaying information to the computer user. Moreover, computer system 112 also includes a data storage device 104 (e.g., disk drive) for storing information and instructions.

Also included in computer system 112 is an optional alphanumeric input device 106. Device 106 can communicate information and command selections to central processor 101. Computer system 112 also includes an optional cursor control or directing device 107 coupled to bus 100 for communicating user input information and command selections to central processor 101. Computer system 112 also includes signal communication interface (input/output device) 108, which is also coupled to bus 100. Communication interface 108 can also include wireless communication mechanisms.

Hierarchical Configuration Attribute Storage and Retrieval

FIG. 2 is a block diagram showing the elements of a software architecture 200 implemented on a portal server according to one embodiment of the present invention. Portal servers conventionally enable personal computers (PCs) to access content. Architecture 200 is used by a portal server to provide content to a variety of different types of devices that have limited capabilities and features in comparison to conventional PCs, or that have characteristics and properties different than a PC. For example, a mobile device might use Wireless Markup Language (WML) rather than HyperText Markup Language (HTML). More specifically, architecture 200 enables mobile access to content provided by a portal server. Architecture 200 can be implemented on a portal server on top of existing software, allowing the portal server to service PCs as well as mobile devices such as cell phones and personal digital assistants (PDAs).

In the present embodiment, architecture 200 includes the following blocks: mobile portal 210, channels 212, mobile Web applications 214, studio 216, mobile context block 218, identity block 220, services block 222, mobile rendering block 224, and an attribute abstraction layer 250. It is appreciated that architecture 200 can include elements in addition to those shown, and can also include other elements not shown or described herein. Furthermore, the blocks shown by FIG. 2 can implement additional functions not described herein.

A user first interacts with a portal server via mobile portal 210, which provides a summary of the services available to the user and which also provides links to the various Web applications. Identity block 220 is for storing persistent data such as credentials utilized for authentication of the user. Identity block 220 can be implemented on the portal server or on another server known as an identity server.

Each of the channels 212 represents an aggregation of different services (e.g., services 222). Services in services block 222 are exemplified by applications such as electronic mail (e-mail), address book, and calendar applications. Mobile Web applications 214 represent applications that can be used by mobile client devices. Studio 216 allows the development of Web applications and channels that can be used in the mobile environment.

Mobile rendering block 224 identifies the type of client device that is accessing the portal server, and the characteristics or properties of that device. These characteristics include but are not limited to screen size, buffer size, and markup language used. Once the type of device is known, content can be formatted for the device. Mobile context block 218 can identify content that is independent of the type of client device and content that depends on the type of client device. For device-dependent content, mobile context block 218 sets up an environment that is correct for the type of client device that is accessing the portal server.

In the present embodiment, architecture 200 includes an attribute abstraction layer 250 that has functionality distributed between mobile portal 210 and identity block 220. Attribute abstraction layer 250 is for storing and retrieving client-aware (device-dependent) attributes used by architecture 200. Attribute abstraction layer 250 stores attributes in a client-aware fashion. When an attribute is requested, attribute abstraction layer 250 can retrieve the suitable attribute based on the type of device. As noted above, the type of device can be identified by mobile rendering block 224. Alternatively, the device itself can provide information that identifies its type.

An attribute can be a Uniform Resource Locator (URL), a bookmark, an authentication module, or some other property of an application or service that is device-dependent. These attributes may be presented to the client device for use. For example, a device-dependent URL or bookmark might be provided to the client device for display on the client device. Attributes may instead be used by the portal server as it provides services to the client device. For example, the portal server might store one type of authentication module for a wireless client and another type of authentication module for a PC client. For instance, the mobile station integrated services digital network (MSISDN) authentication module can be stored for wireless clients but not for PC clients.

Consider a bookmark for a Web site such as Yahoo. A bookmark for an HTML client may forward the client to http://www.yahoo.com, while a bookmark for a Wireless Access Protocol (WAP) client may forward the client to http://wap.yahoo.com. The first site is likely not usable by a WAP device, and the second site is likely not usable by an HTML device. However, architecture 200 provides the capability for a portal server to service both of these client types. When for example a WAP device seeks access to Yahoo, attribute abstraction layer 250 of architecture 200 will retrieve the appropriate attribute (e.g., http://wap.yahoo.com).

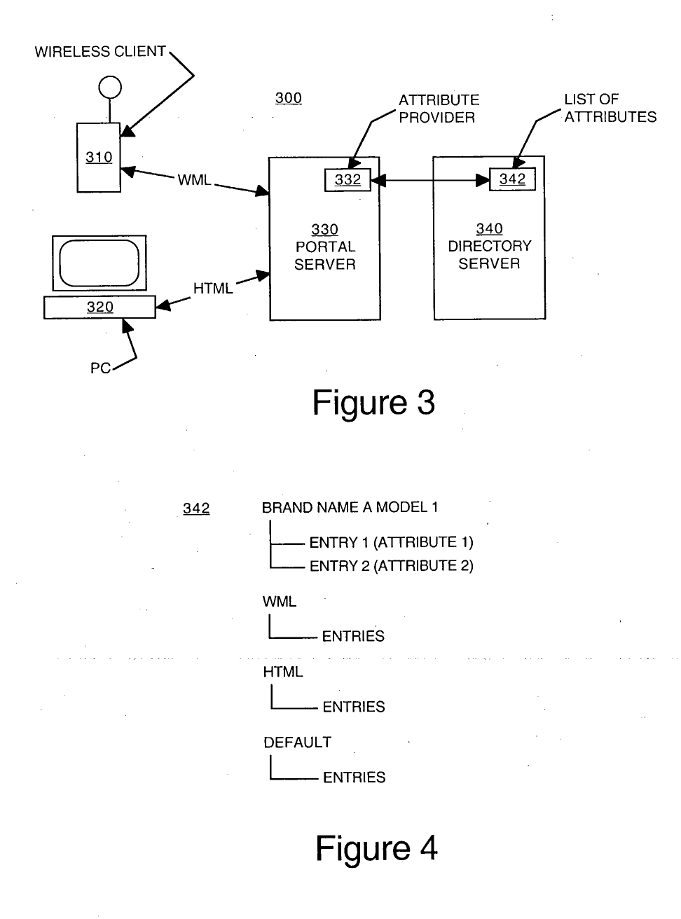

FIG. 3 is a block diagram of an exemplary network 300 according to one embodiment of the present invention. In the present embodiment, network 300 includes a portal server 330 and a directory server 340. It is appreciated that the functionality provided by portal server 330 and directory server 340 can alternatively be integrated into a single server.

Client devices 310 and 320 communicate with portal server 330 and, for purposes of the discussion herein, are assumed to have different capabilities and features. For example, they may have different display, processing or memory capabilities, they may use different markup languages, or they may have other distinguishable capabilities and features. Client device 310 is exemplified as a wireless client device that communicates with portal server 330 using a markup language such as WML, and client device 320 is exemplified as a PC that communicates with portal server 330 using HTML. It is appreciated that the features of the present invention are not limited to the example illustrated by FIG. 3.

In the present embodiment, portal server 330 includes functionality that is represented as attribute provider 332, and directory server 340 includes functionality that is represented as a list of attributes 342. Attribute provider 332 implements the functionality of attribute application layer 250 of FIG. 2. For example, attribute provider 332 may be a bookmark provider, and list of attributes 342 may be a list of bookmarks.

Significantly, attribute provider 332 stores attributes in list 342 in a client-aware fashion, and retrieves from the list 342 an attribute or attributes suitable for the particular type of client device that has accessed the portal server 330. That is, for example, a user of a WML client may bookmark a Web site for future reference. Attribute provider 332 associates the selected bookmark with that WML device and stores the attribute in list 342. In a later session with portal server 330 using the same type of WML device, the type of device is identified to attribute provider 332, which can then retrieve from list 342 the bookmarks suitable for that type of device. As will be seen by the discussion below, the list of attributes 342 can be organized using a hierarchical scheme that facilitates storage and retrieval of attributes.

FIG. 4 is a representation of a list 342 of device-dependent attributes organized using a hierarchical scheme according to an embodiment of the present invention. In this embodiment, list 342 includes device-specific categories for specific types of client devices. For example, a type of client device may be identified using its brand name and model number. If so, list 342 can include a category corresponding to that particular type of client. That is, list 342 will include a category for that particular combination of brand name and model number. Each category can include one or more entries (attributes) associated with a specific type of client device.

List 342 can also include broader categories corresponding to the characteristics of the types of client devices. For example, client devices may be characterized according to the markup language they use (e.g., HTML, WML, etc.), and list 342 can include categories corresponding to the different characteristics. That is, list 342 can include a category for each device characteristic. Each category can include one or more entries (attributes) associated with a specific characteristic of a range of types of client devices. In other words, while a category associated with a specific type of device (identified by a particular combination of brand name and model number, for example) includes attributes for the specific type of device, a category associated with a characteristic can include attributes that can be used with multiple types of devices (e.g., with multiple brand names and model numbers). Thus, a WML category can include attributes for different types of devices that have in common their use of WML.

List 342 can also include a category referred to as the default category. The default category includes attributes that are not device-dependent. For example, there may be Web sites that are client-aware, or there may be services that are independent of the type of device. Such services can include e-mail, address book, and calendar services.

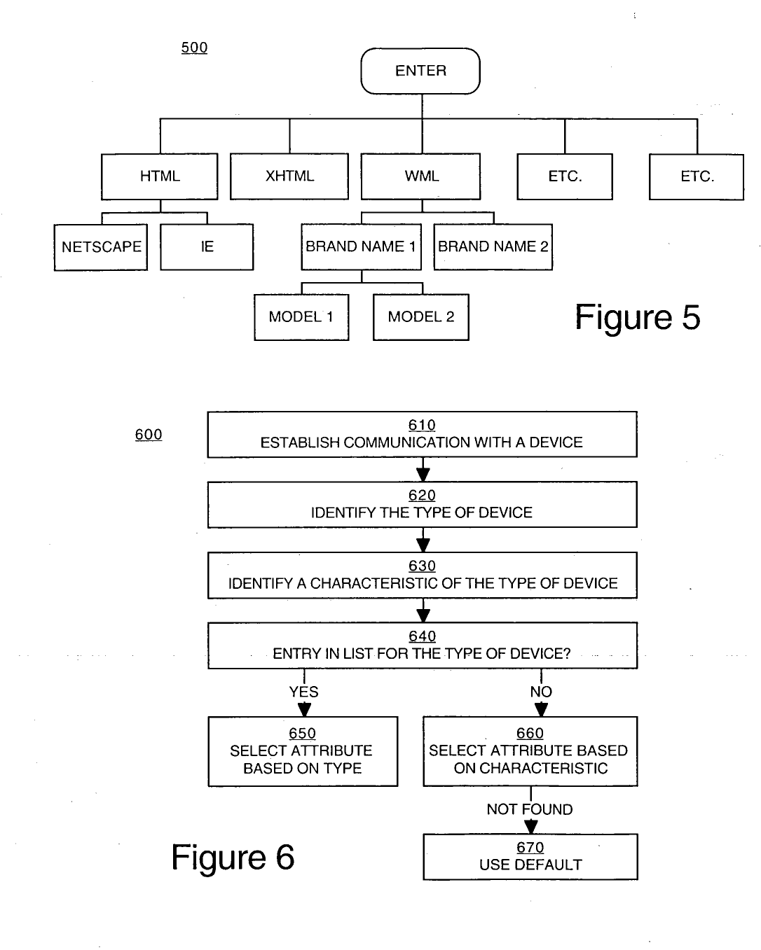

FIG. 5 is a representation of a portion of a directory 500 according to an embodiment of the present invention. The directory 500 can reside on directory server 340 of FIG. 3, or alternatively it can reside on the portal server 330 (FIG. 3). The directory 500 is used to identify the characteristics of a client device that has accessed the portal server.

For example, a PC might access the portal server using Netscape as its browser. Directory 500 of FIG. 5 identifies HTML as a characteristic of Netscape. In a similar manner, a mobile client identified by its brand name, or brand name and model number, is associated with WML.

It is appreciated that directory 500 can include elements other than those illustrated, and that the hierarchy can include additional levels. Also, it is appreciated that a characteristic can itself be a subset of another characteristic. For example, associated with the WML node may be a first node associated with a brand name. Associated with the brand name node may be other nodes dealing with various series of model numbers (e.g., a series 7000 node, a series 8000 node, etc.), and associated with each of the series nodes may be nodes dealing with the various model numbers (e.g., under the series 7000 node, there would be nodes for model numbers 7110, 7120, etc.).

FIGS. 6 and 7 are used to describe embodiments of the present invention in operation. FIG. 6 is a flowchart 600 of one embodiment of a process for retrieving device-dependent attributes. FIG. 7 is a flowchart 700 of one embodiment of a process for storing device-dependent attributes. Although specific steps are disclosed in flowcharts 600 and 700, such steps are exemplary. That is, embodiments of the present invention are well suited to performing various other steps or variations of the steps recited in flowcharts 600 and 700. It is appreciated that the steps in flowcharts 600 and 700 can be performed in an order different than presented, and that not all of the steps in flowcharts 600 and 700 may be performed. In one embodiment, the methods of flowcharts 600 and 700 are implemented by a computer system such as computer system 112 of FIG. 1. More specifically, the methods of flowcharts 600 and 700 can be implemented by attribute abstraction layer 250 acting on portal server 330, perhaps in combination with directory server 340 of FIG. 3.

With reference first to FIG. 6, in step 610, communication between a client device and a portal server is established. For example, with reference to FIG. 3, wireless client 310 or PC 320 establish communication with portal server 330. Such communication can be wireless or wired.

In step 620 of FIG. 6, the type of device is identified. The device can be identified as a PC, for example, or as a wireless client. In the latter case, the wireless client can be more specifically typed. For example, the wireless client can be identified according to the combination of the device's brand name and model number (e.g., brand name A model 1).

In step 630, a characteristic or characteristics of the type of device are identified. For example, by drawing on the information in directory 500 (FIG. 5), the markup language used by the type of device can be identified. For brand name model 1, directory 500 identifies WML as a characteristic.

Note that the type of device is in essence a subset of the characteristic, because a characteristic can be shared by many different types of devices. For instance, WML may be used by a first wireless client device typed by a first combination of brand name and model number (e.g., brand name A model 1) as well as by a second wireless client device typed by another combination of brand name and model number (e.g., brand name A model 2, or a model under brand name B). The first and second wireless client devices can be considered subsets of the set of WML devices. In addition, as described above, a characteristic may be a subset of another characteristic.

In step 640 of FIG. 6, a list of attributes is searched based on the type of device identified in step 620. In one embodiment, with reference also to FIGS. 3 and 4, attribute provider 332 searches the list of attributes 342 for a category based on the type of device. For example, the type of device might be identified as brand name A model 1. The list 342 of FIG. 4 is searched for a category corresponding to brand name A model 1. If there is such a category in list 342, then flowchart 600 proceeds to step 650; otherwise, flowchart 600 proceeds to step 660. In the case in which a PC accesses the portal server using HTML, for example, a specific type of device is not identified, and flowchart 600 would proceed to step 660.

In step 650 of FIG. 6, the attributes in the category associated with the particular type of device (from step 620) are retrieved. Referring to FIG. 4, there are two entries or attribute values (e.g., entry 1 and entry 2) in the list 342. One or all of these entries can be retrieved depending on the application.

In step 660, the attributes in the category associated with the particular characteristic (from step 630) are retrieved when there is not a category in the list 342 (FIGS. 3 and 4) corresponding to the particular type of device. For example, there is not a category in list 342 for a client device identified as brand name model 2. From directory 500, it is determined that brand name model 2 has WML as a characteristic. Therefore, attributes for brand name model 2 are retrieved from the WML category in list 342.

Significantly, the list 342 of attributes is thus searched first for the more specific category based on device type, then on the less specific category based on device characteristic. This not only facilitates the search of list 342, but also results in the retrieval of attributes that are likely the most suitable for the accessing client device.

In step 670 of FIG. 6, when an attribute cannot be selected based on either the device type or characteristic, then default attributes are used.

With reference now to FIG. 7, a process for storing device-dependent attributes is described. In step 710, information is received identifying the type of device for which an attribute is to be stored. Significantly, this identifying information can be received from the device itself, or from another device. In the former case, a client device establishes communication with the portal server, and the portal server identifies the particular type of device (by brand name and model number, for example). When an attribute is selected and stored, the attribute is associated with the accessing device. In the latter case, communication is established with a first device, which identifies a second type of device that is to be associated with the attribute. When an attribute is selected and stored in the latter case, the attribute will be associated with the second type of device rather than (or in addition to) the first device.

In step 720, an attribute is selected. For example, a URL for a particular Web site may be selected or a bookmark may be set. Attributes other than these examples can be selected.

In step 730 of FIG. 7, the attribute is stored in a list of attributes that is sorted into categories based on types of devices, such as list 342 of FIGS. 3 and 4. The list can also include categories sorted on device characteristics. Steps 740, 750 and 760 of flowchart 700 are used to determine in which of the categories the attribute is to be stored.

In step 740 of FIG. 7, a determination is made whether list 342 (FIGS. 3 and 4) already includes a category for the type of device identified in step 710. If so, flowchart 700 proceeds to step 750; otherwise, flowchart 700 proceeds to step 760.

In step 750 of FIG. 7, the selected attribute is added to an existing category corresponding to the particular type of device (from step 710). For example, if the device is identified as brand name model 1, the attribute is stored in the category corresponding to that type of device.

In step 760, in the case in which there is not an existing category in list 342 for the type of device identified in step 710, a new category is created in list 342 for the particular type of device, and the attribute is stored in the new category. Accordingly, subsequent searches of list 342 (FIGS. 3 and 4) are facilitated, and attributes are stored in a hierarchical arrangement that places the attributes in a category that is most suitable for the accessing client device.

Note that, in one embodiment, an attribute can be placed into more than one category. For example, a wireless client device can be identified by a particular combination of brand name and model number and also by a characteristic such as the markup language used (e.g., WML). An attribute associated with the client can be stored in a category that is specific to the type of device, and the attribute can also be stored in a category corresponding to the markup language used.

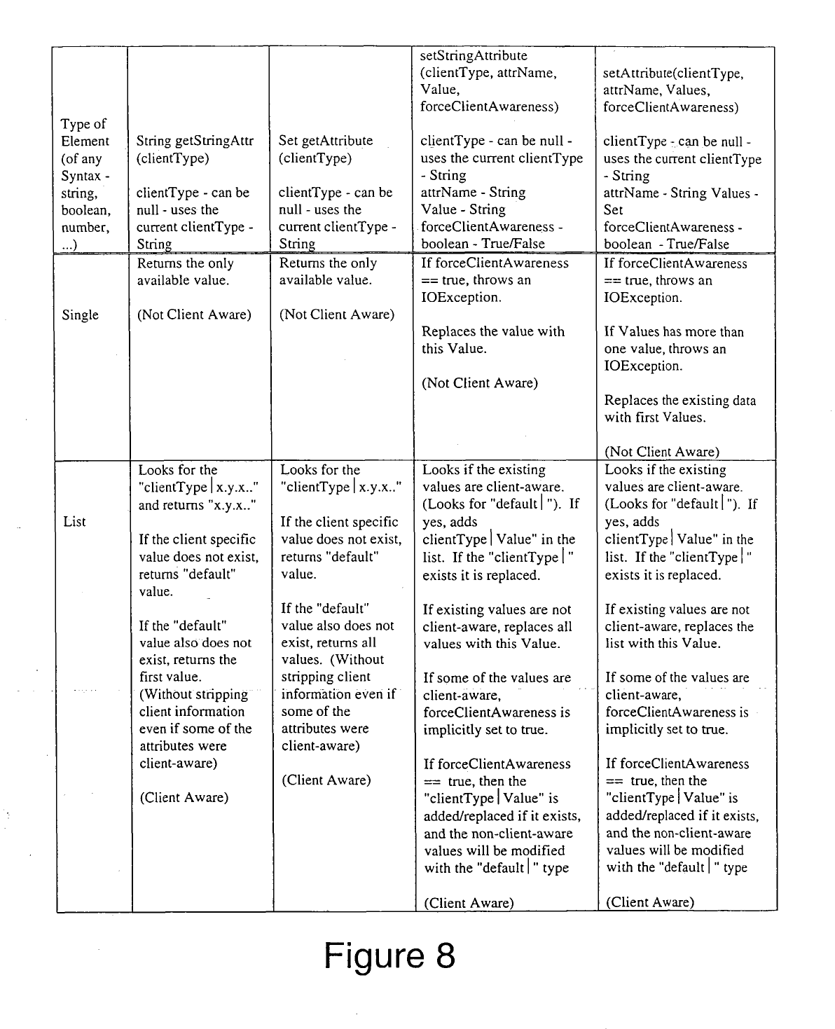

FIG. 8 is a tabulation of one embodiment of an interface for storing and retrieving device-dependent attributes according to embodiments of the present invention. The interface in FIG. 8 describes a well-defined set of rules for retrieving and storing attributes as described herein. In FIG. 8, a single element is exemplified by applications such as e-mail, calendar and address book applications that are not device-dependent. A list element is exemplified by the device-dependent attributes described above in conjunction with FIG. 4, for example.

In summary, embodiments of the present invention allow device-dependent attributes to be readily stored and retrieved on a portal server. As a result, the portal server can quickly and efficiently provide services and other types of support for a wide variety of client devices having different characteristics.

Embodiments of the present invention, hierarchical configuration attribute storage and retrieval, have been described. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of retrieving a device-dependent attribute stored on a portal server, said method comprising:
establishing communication with a device;
identifying a type of said device;
identifying a characteristic of said type of device, wherein said type is a subset of said characteristic; and
retrieving an entry from a list of attributes, said entry selected first according to said type of device and second according to said characteristic if said list does not include an entry that corresponds to said type of device.

2. The method of claim 1 wherein said communication is wireless.

3. The method of claim 1 wherein said type of device is identifiable by a brand name and a model number.

4. The method of claim 1 wherein said characteristic is identifiable by a type of markup language used by said type of device.

5. The method of claim 1 wherein said list of attributes is sorted by device type.

6. The method of claim 1 wherein said list of attributes is sorted by device characteristic.

7. The method of claim 1 wherein said list of attributes further comprises entries that are independent of device type and device characteristic.

8. A method of storing device-dependent attributes in a portal server, said method comprising:
receiving information that identifies a type of device for which an attribute is to be stored, wherein said attribute is dependent on said type of device;
selecting said attribute according to said type of device;
entering said attribute into a list of attributes, wherein said list is organized into type-specific categories, wherein said attribute is entered into a category specific to said type of device provided said category exists; and
creating a new category for said attribute provided said category specific to said type of device does not already exist.

9. The method of claim 8 further comprising establishing a connection with a first device, wherein said attribute is entered into a type-specific category corresponding to a type of said first device.

10. The method of claim 8 further comprising:
establishing a connection with a first device; and
receiving information from said first device identifying a second device, wherein said attribute is entered into a type-specific category corresponding to a type of said second device.

11. The method of claim 8 wherein said portal server is a wireless portal server operable to communicate wirelessly with client devices.

12. The method of claim 8 wherein said type of device is identifiable by a brand name and a model number.

13. The method of claim 8 wherein said list of attributes is sorted by device type.

14. The method of claim 8 wherein said list of attributes further comprises a category for attributes that are independent of device type.

15. A computer-usable medium having computer-readable program code embodied therein for causing a portal server system to perform a method comprising:
communicating with a device;
identifying from said communicating a type of device for which a first attribute is to be stored, wherein said first attribute is dependent on said type of device;
associating said type of device with said first attribute when said first attribute is selected and stored in a list of attributes; and
retrieving a second attribute from said list according to said type of device or according to a characteristic of said type of device if said list does not include an attribute that corresponds to said type of device, wherein said type is a subset of said characteristic.

16. The computer-usable medium of claim 15 wherein said communicating is wireless.

17. The computer-usable medium of claim 15 wherein said type of device is identifiable by a brand name and a model number.

18. The computer-usable medium of claim 15 wherein said characteristic is identifiable by a type of markup language used by said type of device.

19. The computer-usable medium of claim 15 wherein said list of attributes is sorted by device type.

20. The computer-usable medium of claim 15 wherein said list of attributes is sorted by device characteristic.

21. The computer-usable medium of claim 15 wherein said list of attributes further comprises attributes that are independent of device type and device characteristic.

22. The computer-usable medium of claim 15 wherein said first attribute corresponds to said device communicating with said portal server system.

23. The computer-usable medium of claim 15 wherein said first attribute corresponds to another device different from said device communicating with said portal server system, said other device identified during said communicating.
